(19) United States
(12) Patent Application Publication
(10) Pub. No.: US 2011/0055476 A1
(43) Pub. Date: Mar. 3, 2011

(54) RAID Array Access By A RAID Array-unaware Operating System

(76) Inventor: Bryan E. Christ, Tomball, TX (US)

(21) Appl. No.: 12/934,268

(22) PCT Filed: Mar. 27, 2008
(86) PCT No.: PCT/US08/58442

§ 371 Date: Sep. 23, 2010

(51) Int. Cl. G06F 12/00

(52) U.S. Cl. 711/114; 711/E12.001

(57) ABSTRACT

A system comprises a processor configured to execute a first operating system and a second operating system. The system further comprises a plurality of storage drives. The second operating system configures the plurality of storage drives as a RAID array. The first operating system accesses the storage drives without knowledge that the storage drives are configured as a RAID array.

### BACKGROUND

Electromechanical hard drives are susceptible to wear and tear and accidental damage from jarring impacts, power surges, etc. The potential damage to hard drives becomes more severe as the demand for larger capacity hard drives and media density increases. As a result, some users prefer to store their data on redundant array of inexpensive disks (RAID) storage systems. RAID storage systems provide redundancy meaning that one of the drives can fail and the data stored on the failed drive can be recreated from the data on the other drives. Traditional RAID systems offer a reliable way to maintain data in a secure/reliable environment, but can be difficult and expensive to implement.

### BRIEF DESCRIPTION OF THE DRAWINGS

For a detailed description of exemplary embodiments of the invention, reference will now be made to the accompanying drawings in which:

FIG. 1 shows a system diagram in accordance with various embodiments;

FIG. 2 shows the relationship between two operating systems and a hypervisor in accordance with various embodiments; and

FIG. 3 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a portion of a computer, a combination of computers, etc.

### DETAILED DESCRIPTION

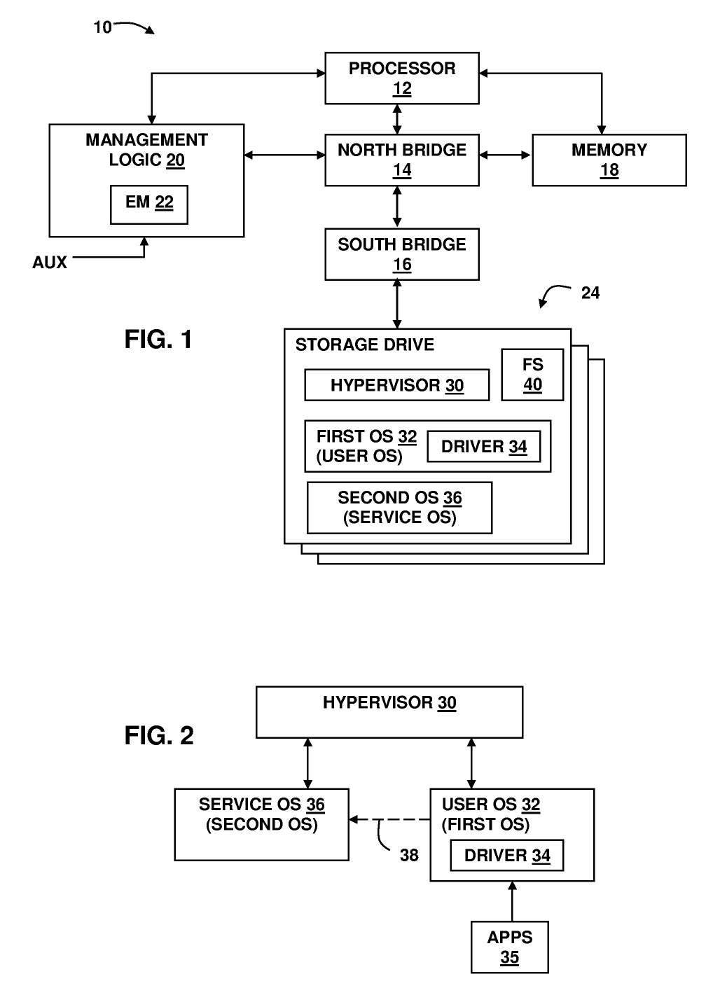

FIG. 1 shows a system 10 in accordance with various embodiments. As shown, system 10 comprises a processor 12, a North bridge 14, a South bridge 16, memory 18, management logic 20, and multiple storage drives 24. In at least some embodiments, the storage drives comprise hard disk drives or other forms of non-volatile storage that can be configured into a RAID array.

In at least some embodiments, the management logic 20 couples to, and is thus separate from, the processor 12 and North bridge 14 and comprises a semiconductor device (e.g., microcontroller) that performs one or more functions. At least one function is to provide “back door” access to system 10 by, for example, information technology (IT) personnel. Via the management logic 20, the system 10 can be monitored and, if necessary, adjusted from a remote location. Examples of such adjustments include loading a new driver, changing a configuration setting, etc. The management logic 20 is operated from an “auxiliary” power feed 21 which is active even when the system 10 is otherwise powered off. The auxiliary power feed 21 enables a remote user (e.g., IT personnel) to boot up, monitor and/or adjust the system 10 from a remote location when the system is otherwise powered off.

Access to the storage drives 24 (e.g., read and write accesses) occurs via the North and South bridges 14 and 16. At least one of the storage drives 24 contains a hypervisor 30 and a pair of operating systems (OS) 32 and 36 (referred to herein as “first” and “second” operating systems). In some embodiments, the first and second operating systems are referred to as user and service operating systems, respectively. The second (service) operating system 36 is used by the management logic 20 to provide the back door service access (hence the name “service” operating system) noted above. The first (user) operating system 32 provides the platform on which the system's user applications run (hence the name “user” operating system). User applications run under the user OS 32 and may be generally unaware of the existence of the second operating system 36 exists. Further, the first operating system 32 is generally unaware of the existence of the second operating system. Accordingly, the second (service) OS 36 is generally regarded as being “transparent” to the users, user applications and first (user) OS 32, while the first OS 32 is regarded as being “exposed” to the users and user applications. In some embodiments, the first (user) OS 32 is subservient to the second (service) OS 36 meaning that the first (user) OS 32, for example, channels network interface controller (NIC) and audio requests (if an audio subsystem is provided) to the second (service) OS 36. Accordingly, the second OS 36 can be considered the primary OS.

The hypervisor 30 comprises executable code that enables two or more operating systems (in this case, user OS 32 and service 36) to run in the same system 10. At least one function performed by the hypervisor 30 is to enable communications between the user and service operating systems 32, 36. Each operating system may implement a different protocol for messages to be provided to, or sent by, such operating system. The hypervisor 30 is programmed with the message format of each operating system 32, 36 and thus can facilitate intra-operating system communications.

The management logic 20 comprises embedded memory 22. The embedded memory 22 contains a piece of executable code that, upon initialization of management logic 20, causes the management logic to load the second (service) operating system 36 from one of the storage drives 24 to memory 18. In accordance with various embodiments, the service (second) operating system 36 is pre-configured to configure the storage drives 24 as a RAID array. In some embodiments, the service OS 36 comprises the Linux operating system or other operating system that can create and use RAID arrays. Linux has the capability to configure storage drives as a RAID array. A user can specify various parameters to be used during the RAID array creation process such as number of drives, stripe size, etc. When the service OS 36 is loaded, the service OS begins to configure the storage drives as a RAID array in accordance with the preset parameters. Because the service OS 36, not the user OS 32, has configured the RAID array, the user OS 32 generally has no knowledge that the storage drives 24 have been configured to operate as a RAID array.

Referring to FIG. 2, the user OS 32, via applications 35, running thereon, issues access requests (read and/or write) for a target storage drive 24. Such a request is provided to the service OS 36. In some embodiments, the request is provided from the user OS 32 to the hypervisor 30, and through the hypervisor 30 to the service OS 36. In other embodiments, the request bypasses the hypervisor 30 and is provided from the user OS 32 directly to the service OS 36 as indicated by dashed arrow 38. In embodiments in which the storage drive access request flows through the hypervisor 30, the driver 34 in the user OS 32 (via driver 34) formats the request into a format compatible with the communication protocol of the hypervisor. The hypervisor 30 then converts the request into a format compatible with the service OS 36. The service OS 36 then converts the request into a form compatible with the RAID array. Linux, which already comprises the ability to create RAID arrays, has the capability to receive an access request from an application running under Linux and to convert the request to a format compatible with a RAID array. In the disclosed embodiments, however, the request originates from an application 35 running under the user OS 32. If the user OS 32 issues a read request, the returned read data from the RAID array is returned to the service OS 36 which, via driver 34, formats the data appropriately for the user OS 32. Again, Linux already has the ability to appropriately format data read from a RAID array into a form suitable consumption by an application running under Linux.

In some embodiments, the user OS 32 executes the storage drive access request instead of the service OS 36. In such embodiments, the driver 34 in the service OS 32 is implemented with the ability to configure the storage drives 24 as a RAID array instead of the service OS 36. Such a RAID-cognizant driver 34 can execute an access request from an application running under the user OS 32 and format the access request in a format suitable for accessing the RAID array, much the same as the service OS 36 did in the preceding embodiment. Return data from a read request is also formatted by the driver 34 as discussed above.

Further, in such an embodiment with more than one OS present and able to access the storage drives 24, each OS atomically accesses the RAID array. A file system (FS) 40 is provided by which an OS accesses the target data (e.g., file) in the RAID array. In such embodiments if the user OS 32, via driver 34, attempts to access the RAID array, the user OS 32 must obtain exclusive use of the file system 40 to prevent the service OS 36 from concurrently accessing the RAID array. Concurrent access by two different OS's may, for example, corrupt metadata (e.g., identity of time of last access, etc.) stored on the RAID array by the accessing OS. A lock variable, such as flag, can be used to grant exclusive access to one OS or the other. If the lock variable is set to the lock value, no other OS can access and use the file system 40. In some embodiments, the hypervisor 30 stores the lock variable and thus the OS's 32 and 36 access the hypervisor to obtain exclusive use of the file system 40.

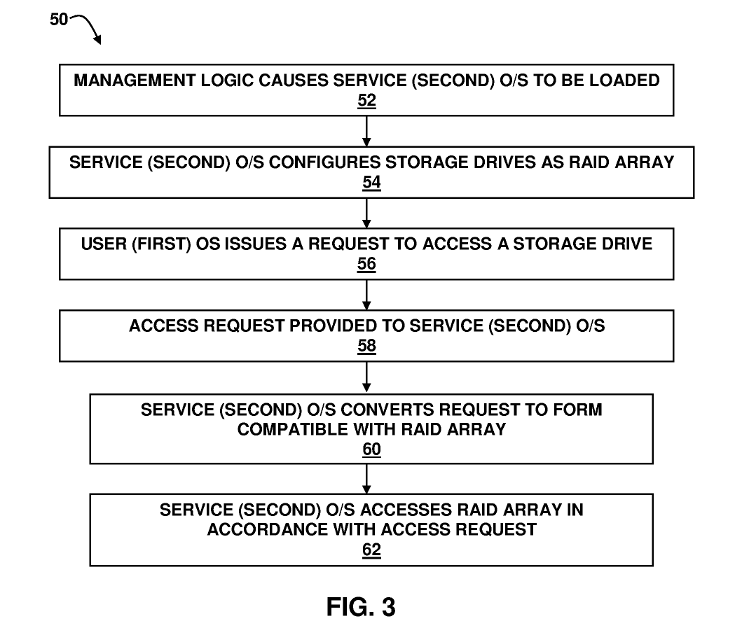

FIG. 3 shows a method 50 in accordance with various embodiments. As shown, method 50 comprises the management logic 16 causing the service OS to be loaded from a storage drive 24 into memory 18 (52). At 54, the method comprises the service OS 36 configuring the storage drives 24 as a RAID array. At 56, the user OS 32 issues a request for access to a storage drive 24. At 58, the access request is provided to the service OS 36 (e.g., via the hypervisor 30 or directly bypassing the hypervisor). At 60, the service OS 36 converts the request for storage drive access to a form compatible with the RAID array. At 62, the method comprises the service OS accessing the RAID array in accordance with the access request.

The software discussed herein—the hypervisor 30, first (user) OS 32, second (service OS) 36 and file system 40—are provided on any suitable computer-readable medium such as a storage drive 24, compact disc read-only memory (CD ROM), read-only memory (ROM), volatile memory (e.g., random access memory), or combinations thereof. Such software causes the processor 12 and/or management logic 20 to perform some or all of the functions described herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a processor configured to execute a first operating system and a second operating system;
a plurality of storage drives;
wherein said second operating system configures said plurality of storage drives as a RAID array and said first operating system accesses said storage drives without knowledge that said storage drives are configured as a RAID array.

2. The system of claim 1 further comprising a hypervisor accessible to the first and second operating systems.

3. The system of claim 2 wherein said first operating system comprises a driver that causes requests for access to a storage drive to be provided to said hypervisor.

4. The system of claim 2 wherein the hypervisor receives a storage drive access request from the first operating system and provides said storage drive access request to the second operating system for completion.

5. The system of claim 4 wherein the second operating system converts said access request to a form compatible with the RAID array.

6. The system of claim 1 wherein said first operating system provides a storage drive access request to the second operating system to be converted to a form compatible with the RAID array.

7. The system of claim 1 further comprising logic, separate from said processor, that spawns said second operating system.

8. The system of claim 1 wherein said logic also enables access to said system from a network without using said first operating system.

9. A computer-readable medium (CRM) containing software that, when executed by a processor, causes the processor to:
receive an access request from a first operating system for information stored on a storage drive, said access request from the first operating system not being compatible with a RAID array;
convert said access request to a form compatible with a RAID array; and
provide said RAID array-compatible access request to said RAID array;
wherein said first operating system is not programmed to read from and write to a RAID array.

10. The CRM of claim 9 wherein said software causes the processor to configure said RAID array.

11. The CRM of claim 9 wherein said software causes the processor to convert return read data from said RAID array to a format compatible with said first operating system.

12. The CRM of claim 10 wherein said software comprises a hypervisor.

13. The CRM of claim 10 wherein said software comprises a hypervisor, as well as a second operating system that configures said RAID array.

14. A method, comprising:
a second operating system configuring a plurality of storage drives as a RAID array; and
a first operating system accessing said storage drives without knowledge that said storage drives are configured as a RAID array.

15. The method of claim 14 further comprising the second operating system converting a storage drive access request from the first operating system to a form compatible with the RAID array.

16. The method of claim 15 wherein the first operating system provides a request, for access to a storage drive, to the second operating system.

17. The method of claim 15 further comprising causing said second operating system to be loaded by logic separate from a processor that executes said first operating system.
